(19) United States
(12) Patent Application Publication
(10) Pub. No.: US 2021/0105300 A1
(43) Pub. Date: Apr. 8, 2021

(54) METHODS AND SYSTEMS THAT DETECT AND DEFLECT DENIAL-OF-SERVICE ATTACKS

(71) Applicant: Secure64 Software Corporation, Greenwood Village, CO (US)

(72) Inventors: James Grosvenor Garnett, Bellingham, WA (US); Saksham Manchanda, Fort Collins, CO (US)

(73) Assignee: Secure64 Software Corporation, Greenwood Village, CO (US)

(21) Appl. No.: 17/066,430

(22) Filed: Oct. 8, 2020

Related U.S. Application Data
(60) Provisional application No. 62/912,280, filed on Oct. 8, 2019.

(51) Int. Cl. H04L 29/06

(52) U.S. Cl. CPC H04L 63/1458; H04L 63/1425; H04L 63/1416

(57) ABSTRACT

The current document is directed to methods and subsystems incorporated in computer systems that automatically detect denial-of-service (“DoS”) attacks directed to the computer systems and that deflect the denial-of-service attacks with minimal impact to legitimate network traffic. In the described implementation, an automated subsystem is incorporated into a computer system, such as a server, to automatically detect onset of high inbound network traffic symptomatic of a DoS attack and to automatically deflect the attack at the edge-router interface, or at another similar network boundary, between a distributed computer system and a wide-area network (“WAN”) and/or the Internet. DoS-attack deflection at the network boundary decreases the chance of failure and degradation within the distributed computer system by preserving network bandwidth in internal networks within the distributed computer system. Automated detection and deflection of DoS attacks is far more rapid than currently available methods that involve manual operations by human users. Furthermore, the currently disclosed automated subsystem can more precisely and accurately deflect DoS attacks without the inadvertent secondary failures and problems that currently available methods often entail.

### CROSS REFERENCE TO RELATE APPLICATION

This application claims the benefit of Provisional Application No. 62/912,280, filed Oct. 8, 2019.

### TECHNICAL FIELD

The current document is directed to network monitoring and, in particular, to methods and subsystems incorporated in computer systems that automatically detect denial-of-service attacks directed to the computer systems and deflect the denial-of-service attacks with minimal impact to legitimate network traffic.

### BACKGROUND

A denial-of-service (“DoS”) attack is an attempt to degrade or crash a computer system by directing the heavy flow of networking traffic to the computer system. DoS attacks are frequently directed to computer systems that support various types of services used by remote users that access the services through computer networks. Examples include web servers, domain-name servers, telecommunications systems, and e-commerce systems. Often, the attacker employs multiple different external computer systems to flood a server or other computer system with extremely high rates of spurious requests. A DoS attack can result in many different types of degradation and failure. Because of the large number of spurious requests directed to the target computer system, the response times for legitimate users' requests may be increased to the extent that service provision by the computer system becomes useless to the legitimate users. With increasing flows of spurious requests, legitimate users' requests may fail altogether. DoS attacks can degrade the overall performance of networks, particularly internal local-area networks within distributed computer systems, and thus generally degrade distribute-computer-system performance with deleterious effects to many different individual computer systems within a distributed computer system and to many different types of services and applications running within them. Ultimately, the extremely high network traffic generated by DoS attackers can result in system crashes and even hardware failures.

Various methods for detecting and responding to DoS attacks have been developed. However, currently available methods generally require varying levels of manual operation by human system administrators and managers, and may therefore be both too slow to prevent system degradation and system failures and may also be prone to human error, including remedial actions that, while at least partially addressing the DoS attacks, may also inadvertently result in other types of unanticipated degradations and failures. For these reasons, developers and vendors of computer systems, users of computer systems, and system administrators and managers, including security personnel, have all recognized the need for improved detection and management of DoS attacks.

### SUMMARY

The current document is directed to methods and subsystems incorporated in computer systems that automatically detect denial-of-service (“DoS”) attacks directed to the computer systems and that deflect the denial-of-service attacks with minimal impact to legitimate network traffic. In the described implementation, an automated subsystem is incorporated into a computer system, such as a server, to automatically detect onset of high inbound network traffic symptomatic of a DoS attack and to automatically deflect the attack at the edge-router interface, or at another similar network boundary, between a distributed computer system and a wide-area network (“WAN”) and/or the Internet. DoS-attack deflection at the network boundary decreases the chance of failure and degradation within the distributed computer system by preserving network bandwidth in internal networks within the distributed computer system. Automated detection and deflection of DoS attacks is far more rapid than currently available methods that involve manual operations by human users. Furthermore, the currently disclosed automated subsystem can more precisely and accurately deflect DoS attacks without the inadvertent secondary failures and problems that currently available methods often entail.

### BRIEF DESCRIPTION OF THE DRAWINGS

FIG. 1 provides a general architectural diagram for various types of computers.

FIG. 2 illustrates an Internet-connected distributed computing system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-B illustrate two types of virtual machine and virtual-machine execution environments.

FIGS. 6A-B illustrates an example distributed computer system and a DoS attack.

FIGS. 7A-B illustrate components of the networking system and additional components used to implement the currently disclosed methods and subsystems.

FIG. 8 illustrates implementation of source-based source-based RTBH within an edge router.

FIGS. 9A-B illustrate operation of the BGP routing daemon.

FIG. 10 illustrates how the BGP routing daemon determines when to send UPDATE and WITHDRAW messages to the edge router.

FIG. 11 shows the components of the currently disclosed subsystem using different illustration conventions than previously used in FIG. 7B.

FIGS. 12A-13 illustrates a first-order infinite-impulse-response (“IIR”) filter.

FIG. 13 illustrates the logger component of the currently disclosed subsystem.

FIGS. 14A-C provide control-flow diagrams that illustrate operation of the BGP routing daemon.

FIGS. 15A-C provide control-flow diagrams for the logger component of the currently discussed implementation of the currently disclosed subsystem.

FIG. 16 provides a control-flow diagram for the monitor handler called in step 1514 of FIG. 15A.

### DETAILED DESCRIPTION

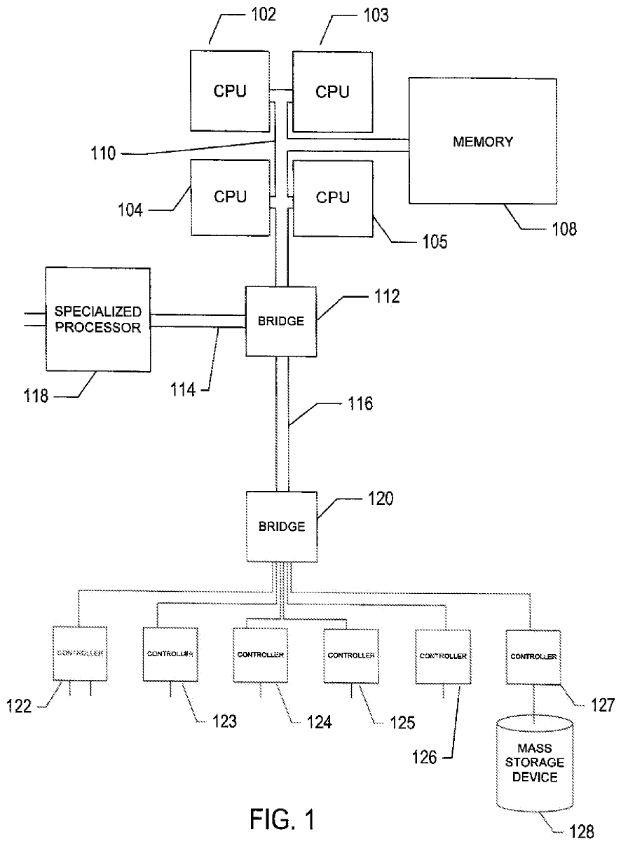

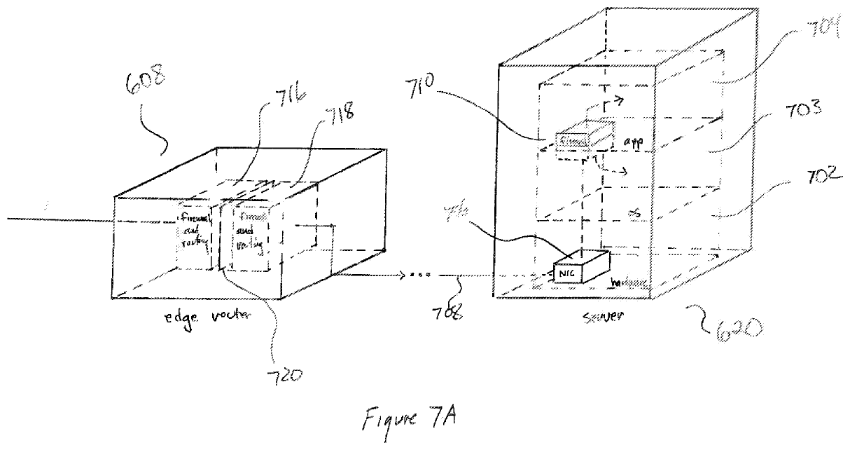

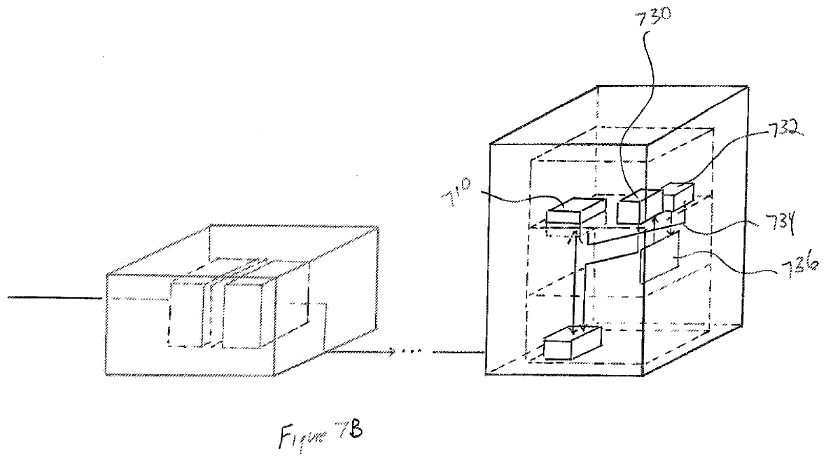

The current document is directed to methods and subsystems that that automatically detect denial-of-service attacks. In a first subsection, below, a detailed description of computer hardware, complex computational systems, and virtualization is provided with reference to FIGS. 1-5B. In a second subsection, the currently disclosed methods and subsystems are discussed with reference to FIGS. 6A-16.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately. using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. The computer system contains one or multiple central processing units (“CPUs”) 102-105, one or more electronic memories 108 interconnected with the CPUs by a CPC/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

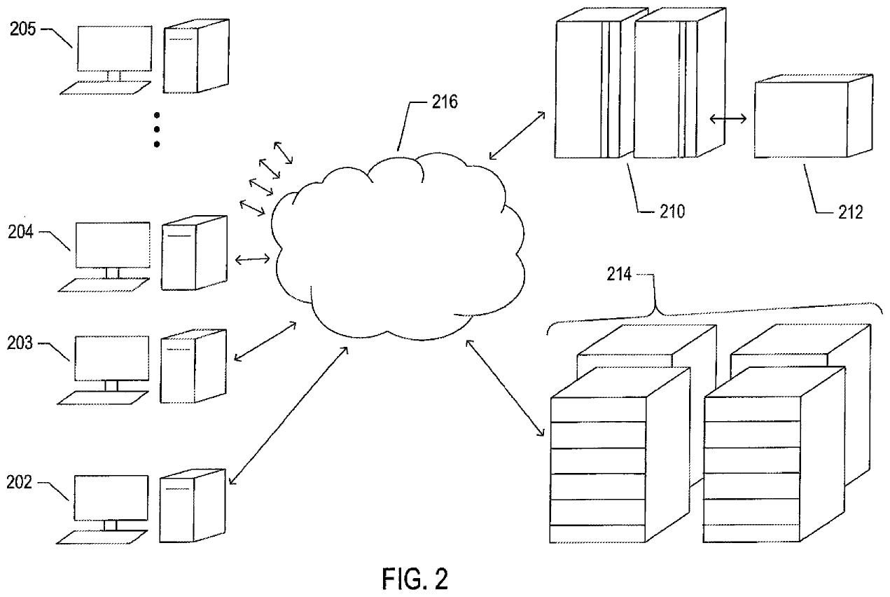

FIG. 2 illustrates an Internet-connected distributed computing system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

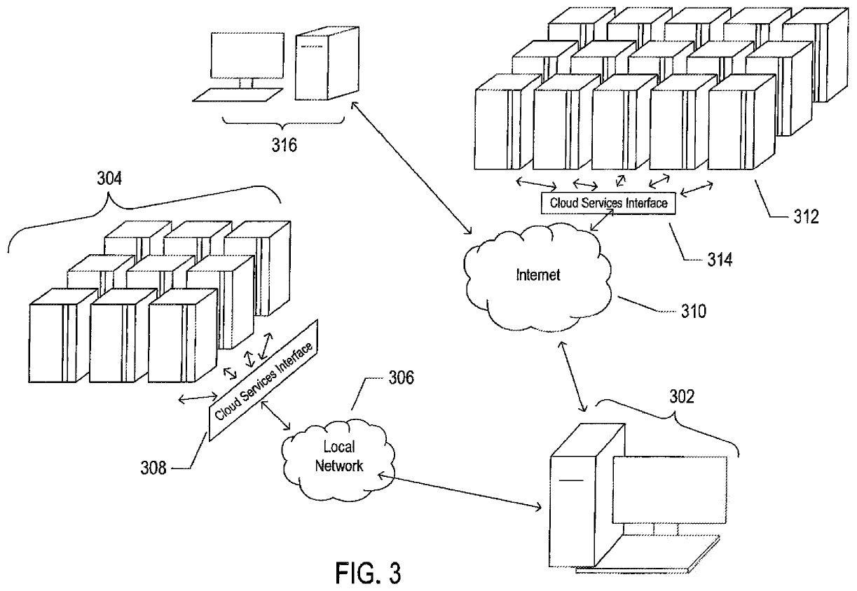

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

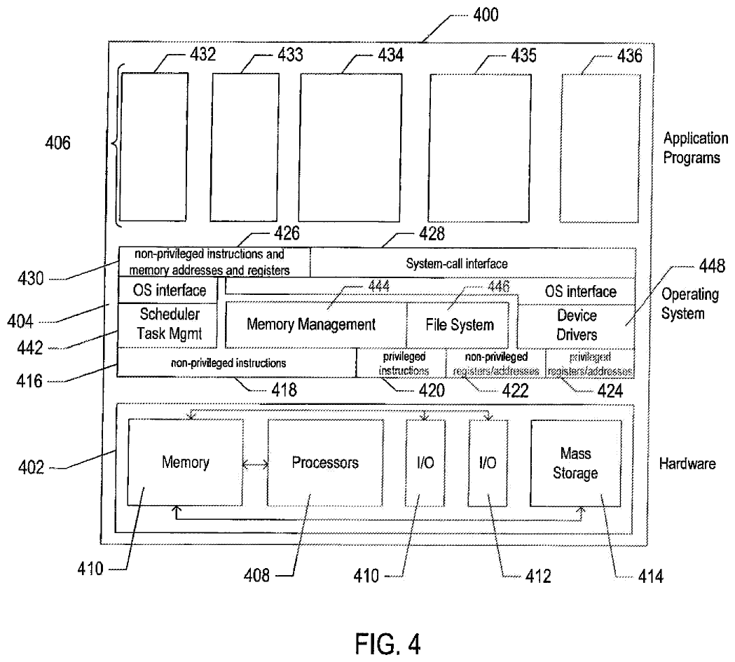

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computing system for high-availability, fault-tolerance, and load-balancing purposes. The problems are even greater in heterogeneous distributed computing systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

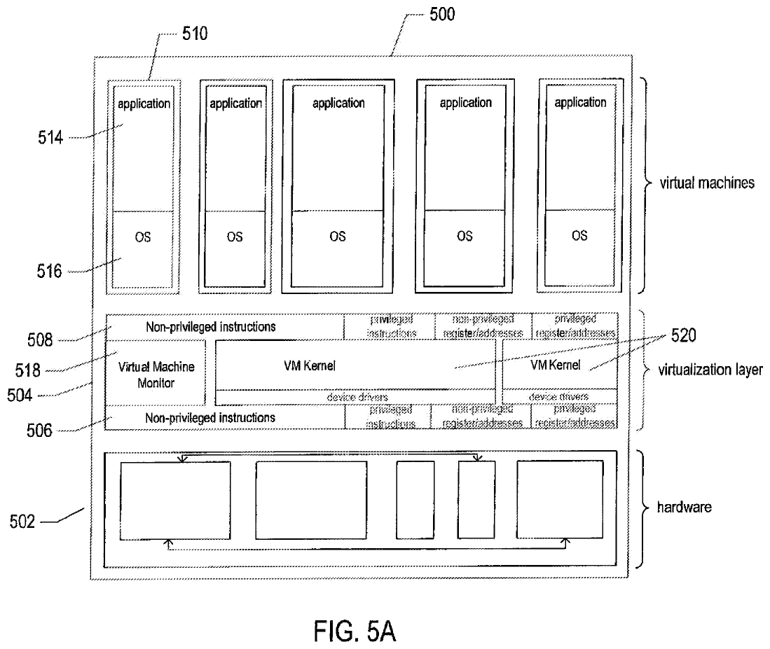

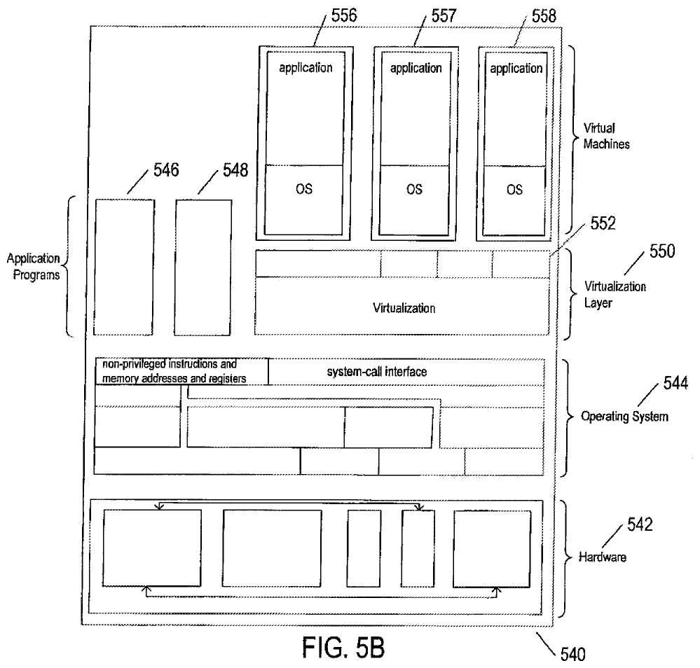

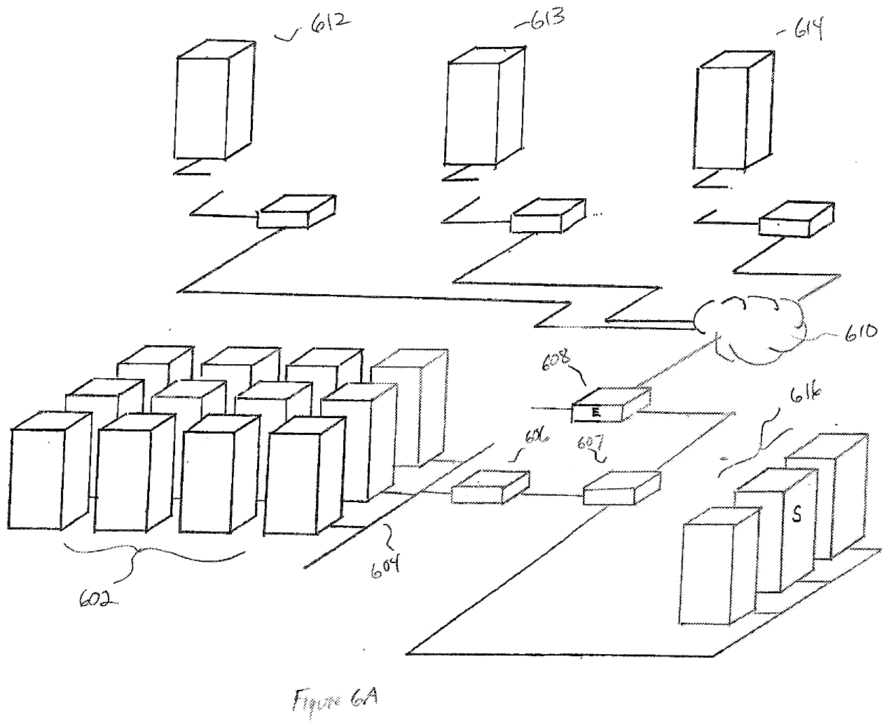

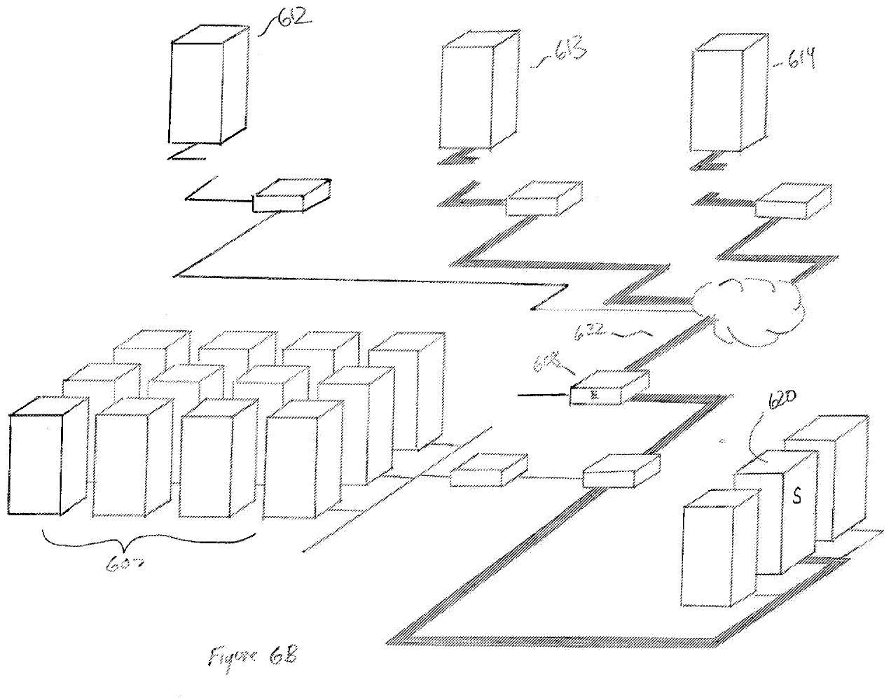

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-D illustrate several types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs. so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

### Currently Disclosed Methods and Systems

FIGS. 6A-B illustrates an example distributed computer system and a DoS attack. As shown in FIG. 6A, the example distributed computer system includes multiple servers 602 interconnected by one or more local internal networks 604 through several core routers 606-607 and an edge router 608 that interconnects the distributed computer system via a WAN and/or the Internet 610 to an external computer systems, represented by three servers 612-614. The distributed computer system contains additional servers 616 located within a networking DMZ. These additional servers provide services and interfaces to external computer systems and are thus placed within the DMZ in order to secure the internal servers 602 from possible attacks through the servers within the DMZ. The core routers 606-607 and edge router 608 are generally protected by a variety of different security features, including access control lists (“ACLs”), black/white lists, and firewalls, and generally support additional types of security methods such as virtual private networks (“VPNs”). Note that the term “server” is used, in this discussion, to mean a discrete computer system within the distributed computer system, and may include individual server computers, server computers with multiple processors, clusters of server computers, and additional types of discrete computer systems.

FIG. 6B illustrates a DoS attack. A malicious entity has gained control of remote computer systems 613 and 614 and has programmed them to send an enormous number of spurious requests to a service application running within target server 620 in the distributed computer system. The network connection 622 leading from the edge router 608 outward to external computers may have sufficient bandwidth to handle the huge flow of spurious requests from external computer 613 and 614, but the bandwidths of internal networks within the distributed computer system generally have smaller bandwidths and may become deleteriously overloaded by the volume of spurious requests generated by the attackers. As result, not only the target system 620 of the attack may be starved for network bandwidth, but other computers in the DMZ as well as the internal computers 602 may suffer significant network-bandwidth degradation. In addition, both the target system and other systems within the distributed computer system may suffer decreases in available processor bandwidths and in available storage-subsystem capacities. The target system 620, in particular, may be overwhelmed by the volume of spurious requests generated by the attackers, as a result of which legitimate users, such as users accessing a service provided by the target system 620 from external computer 612, may be denied access to that service by the DoS attack or may suffer response-time latencies of sufficient magnitude to decrease or eliminate the utility of accessing the service. Ultimately, a DoS attack can so overwhelm a computer system that the computer system may fail altogether.

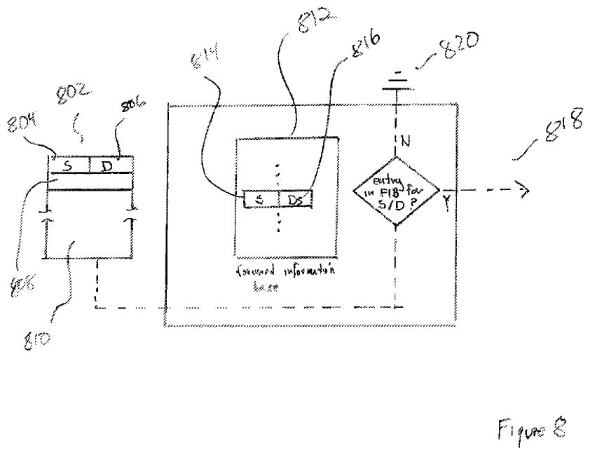

FIGS. 7A-B illustrate components of the networking system and additional components used to implement the currently disclosed methods and subsystems. FIG. 7A shows the target server 620 and the edge router 608 previously shown in FIGS. 6A-B. The target server 620 includes a hardware layer 702, an operating system/virtualization layer 703, and an application layer 704. The hardware layer includes a hardware network interface controller (“NIC”) 706 that connects the target server with a local network 708. Network traffic is passed from the NIC via the operating-system/virtualization layers to a firewall 710 within the target server 620. The firewall is shown, in FIG. 7A, as spanning the application layer 704 and the operating-system/virtualization layer 703. Various different types of firewalls may be implemented at different levels within a computer system and may, in fact, span two different levels. The firewall includes various security features, including access control lists, black/white lists, and stateful intrusion-detection and rule-directed message-filtering technologies to protect the server from malicious and unwanted network traffic. Only legitimate network traffic that does not represent security threats is directed from the firewall to operating-system/virtualization-layer executables and application-layer executables. The edge router 608 includes incoming 716 and outgoing 718 firewalls and routing functionality that employs various types of routing tables and other data 720 stored within the edge router. It is the edge router's task to direct messages received from external computers to the target computers, to which they are addressed, within the distributed computer system and to make external networking components aware of various types of destination addresses within the distributed computer system to which external computers can send network messages.

FIG. 7B illustrates additional components within the server computer employed by the currently disclosed methods and subsystems. A border-gateway-protocol (“BGP”) daemon 730 communicates with the edge router for various purposes, including for directing the edge router to null-route source addresses corresponding to external computers via UPDATE messages and to terminate null-routing of source addresses via WITHDRAW messages, as discussed further below, according to the source-based remotely-triggered black-hole-filtering (“RTBH”) technique based on unicast reverse path forwarding. A logger 732 is a monitoring application-level executable that receives alerts from the firewall 710 that each indicates a firewall-rule violation and the source network address of the messages involved in violating the firewall rule. The alerts are passed from the firewall to the logger via a netlink-channel operating-system messaging subsystem 734. The logger employs various criteria, discussed below, to detect DoS attacks, based on the alerts received from the firewall, and to notify the BGP daemon to send an UPDATE message to the firewall to null-route the source addresses of the incoming DoS-attack messages. The logger communicates with the BGP daemon via a user-accessible kernel routing table 736 maintained by the operating system. Many of the components discussed with reference to FIG. 7B are particular to a particular implementation of the currently disclosed system in a Linux operating-system environment. In many cases, there are alternative approaches for providing the various functionalities provided by these components even in a Linux operating-system environment, and many additional approaches for providing these functionalities in other types of environments.

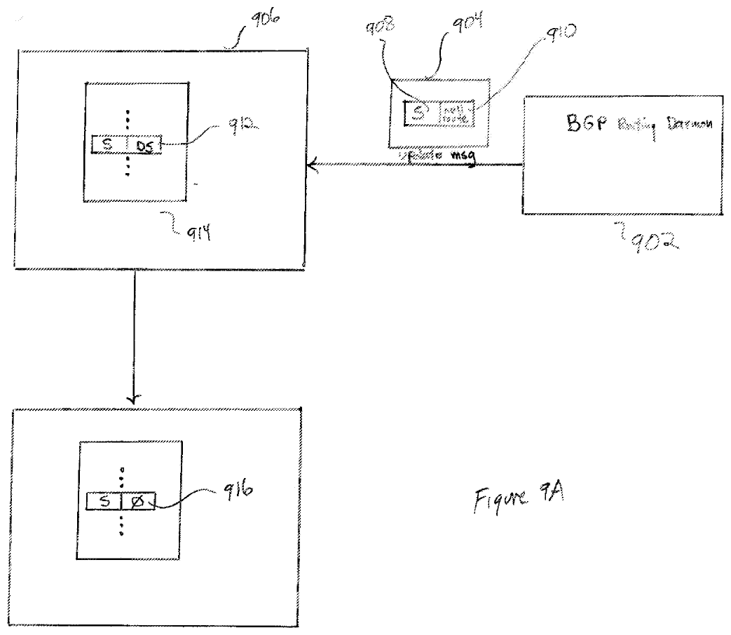

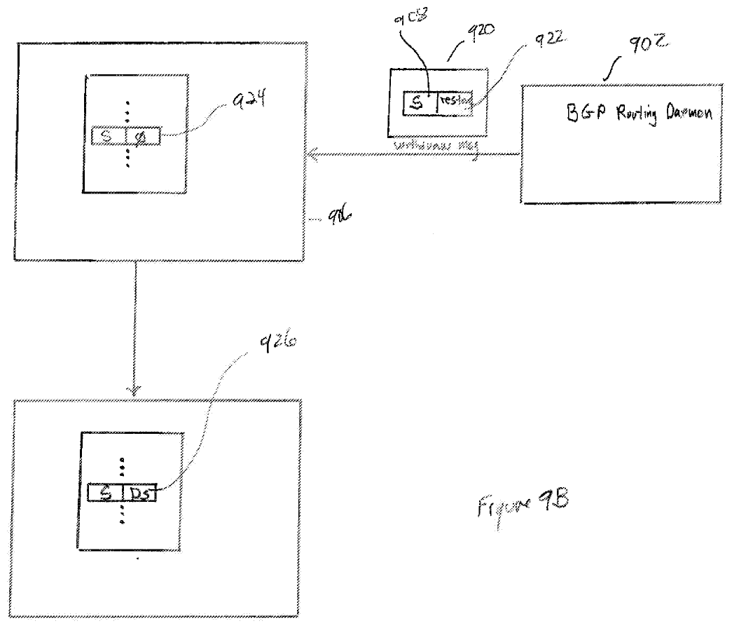

FIG. 8 illustrates implementation of source-based source-based RTBH within an edge router. A network message 802 is shown being received by the edge router. The network message includes a source address 804 and the destination address 806, additional header information 808, and a message body 810. The edge router, upon receiving the message, often after various types of security features have already been applied by the incoming firewall, looks for an entry in a forward-information-base (“FIB”) table 812 that contains the source address of the incoming message. When such an entry is found 814, and when one of the destination addresses 816 in the entry match the destination address 806 in the incoming message, the incoming message proceeds through any additional security features within the edge router and is routed by the edge router to a computer within the distributed computing system corresponding to the destination address 806, as represented by arrow 818. However, if an entry for the source/destination-address pair in the incoming message is not found in the FIB, the messages dropped by the edge router, as represented by symbol 820.

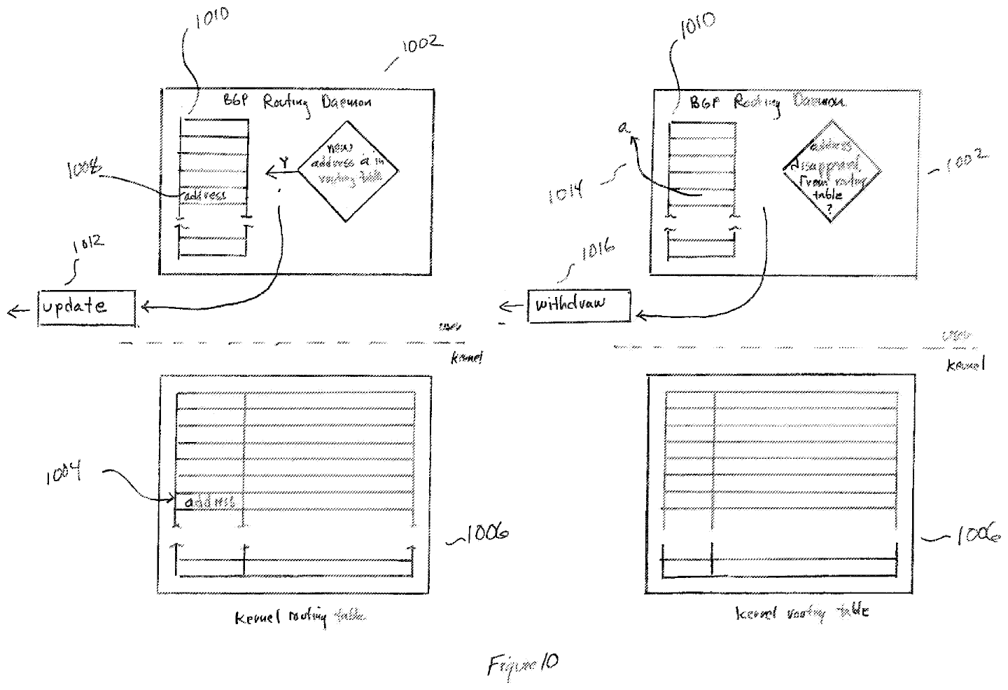

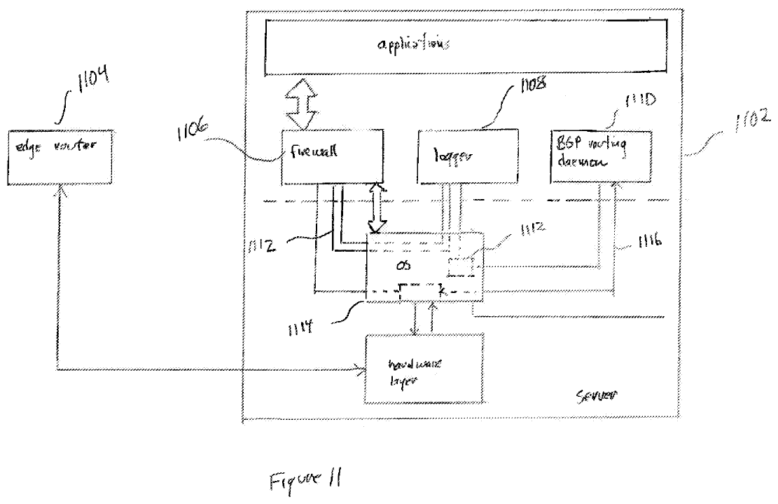

FIGS. 9A-B illustrate operation of the BGP routing daemon. FIG. 9A illustrates the BGP routing daemon directing the edge router to null-route a source address via an UPDATE message. The BGP routing daemon 902 sends the UPDATE message 904 to the edge router 906. The UPDATE message includes the source address 908 in messages deemed to have been received as part of a DoS attack as well as an indication 910 for the source address to be null-routed. The edge router has been configured to recognize the indication of the request for null-routing. In response to receiving the UPDATE message, the edge router finds the appropriate entry 912 in the FIB 914 and sets, to the null-route indication 916, the destination addresses previously reachable by messages including the source address. FIG. 9B illustrates the BGP routing daemon directing the edge router to discontinue null-routing a source address via a WITHDRAW message. In this case, the BGP routing daemon 902 sends the WITHDRAW message 920 to the edge router 906. The WITHDRAW message includes the source address 908 that has been null routed as well as an indication 922 for null-routing of the source address to be discontinued. Again, the edge router has been configured to recognize the indication of the request for discontinue null-routing. In response to receiving the WITHDRAW message, the edge router finds the relevant entry 924 in the FIB and restores the destinations-addresses portion of the entry to one or more valid destination addresses, including the address of the target server 926. There are alternative methodologies that can be used to implement source-based RTBH.

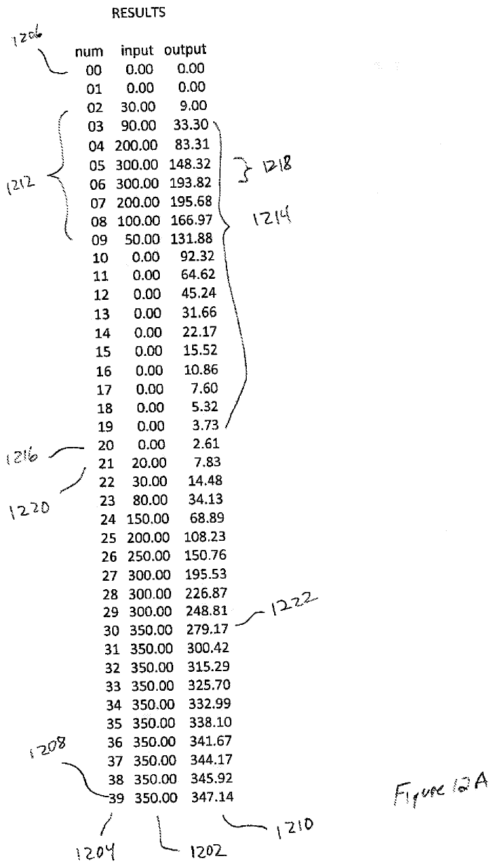

FIG. 10 illustrates how the BGP routing daemon determines when to send UPDATE and WITHDRAW messages to the edge router. As shown in the left portion of FIG. 10, when the BGP routing daemon 1002 finds a new address 1004 in the user-accessible kernel routing table (“krt”) 1006, the BGP routing daemon adds the address 1008 to an internal list of addresses 1010 maintained by the BGP routing daemon and then transmits the UPDATE message 1012 to the edge router. As shown in the left portion of FIG. 10, when the BGP routing daemon later discovers that an address currently included in the internal address list 1010 is no longer represented by an entry in the krt 1006, the BGP routing daemon 1002 removes the address from the internal address list, as represented by arrow 1014, and transmits a WITHDRAW message 1016 to the edge router.

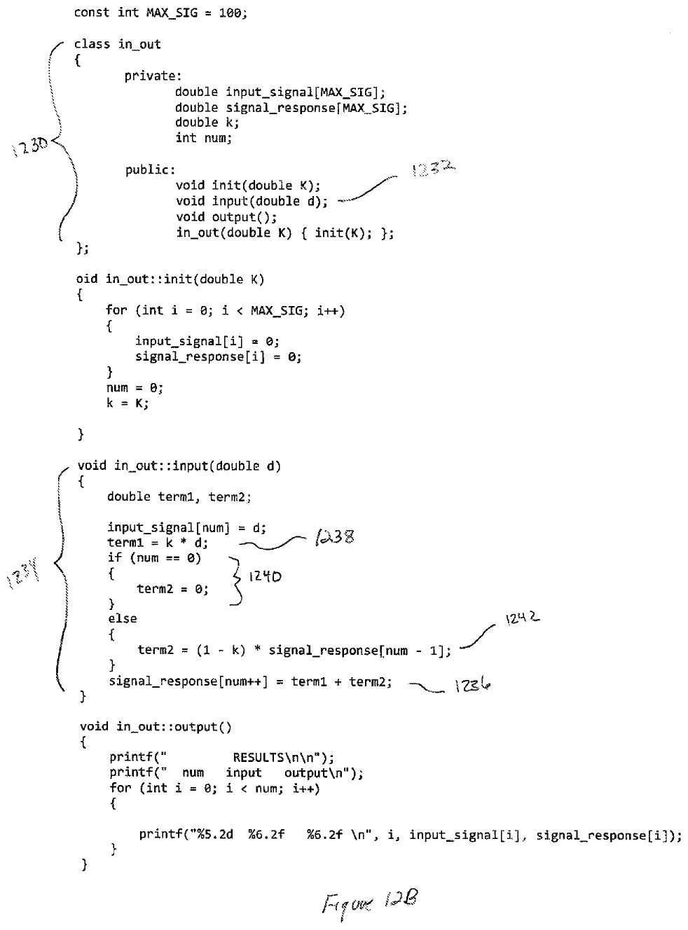

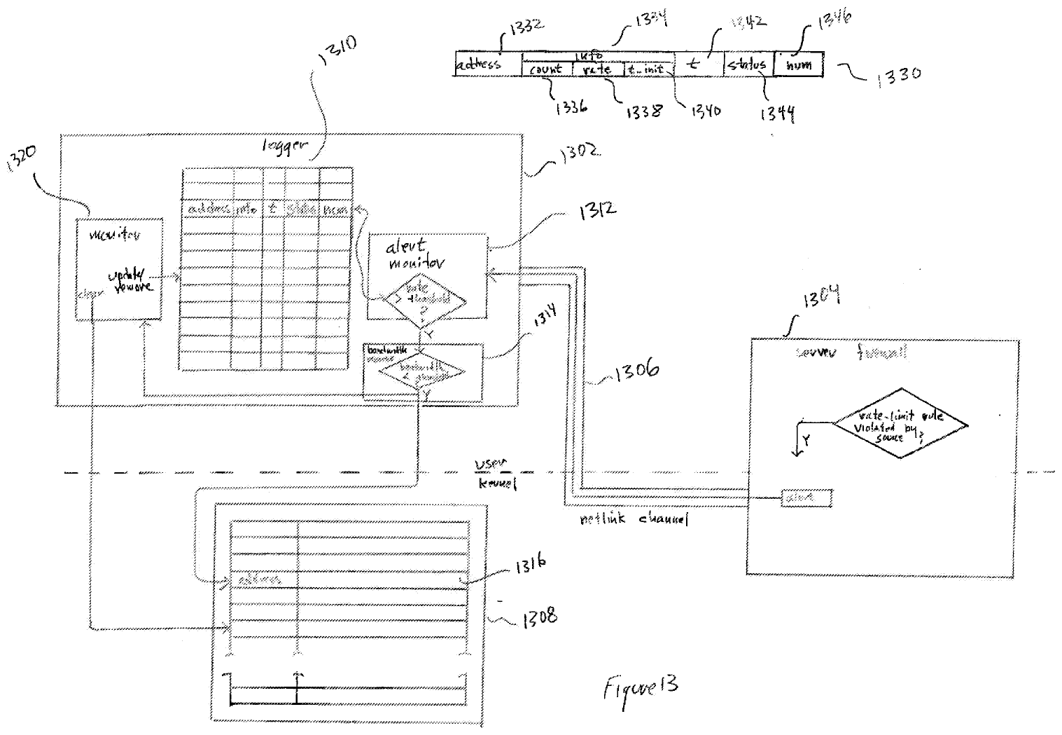

FIG. 11 shows the components of the currently disclosed subsystem using different illustration conventions than previously used in FIG. 7B. As discussed above, the server 1102 exchanges network messages with the edge router 1104. The server 1102 includes the previously discussed firewall 1106, logger 1108, and BGP routing daemon 1110. The logger communicates with the BGP routing daemon via the user-accessible krt table 1112 maintained by the operating system 1114. The logger communicates with the firewall via the netlink-channel operating-the system communications subsystem 1112 and the BGP routing daemon communicates with the edge router via networking messaging 1116. The logger is responsible for detecting DoS attacks based on alerts sent from the firewall to the logger and for directing the BGP routing daemon to communicate null-routing directives to the edge router. The logger is also responsible for deciding when to discontinue null-routing source addresses, when it is likely that a previously detected DoS attack has subsided.

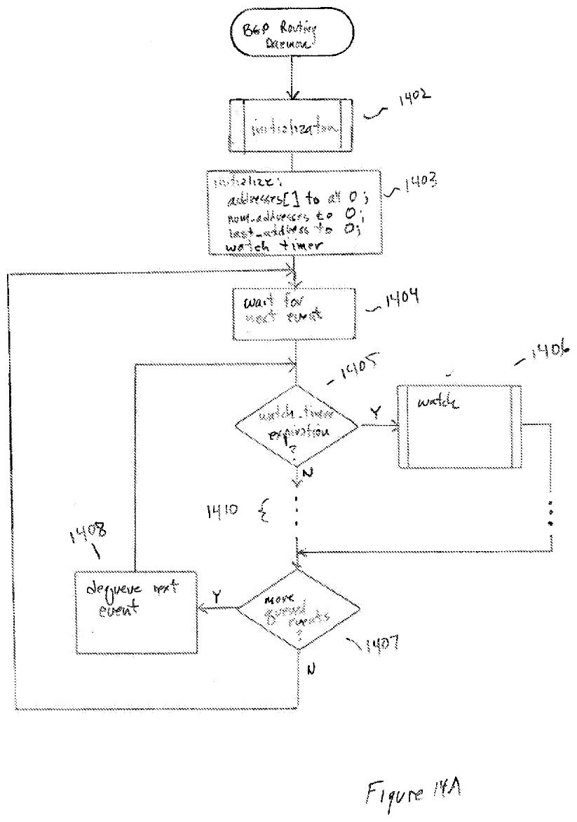

FIGS. 12A-B illustrates a first-order infinite-impulse-response (“IIR”) filter. The FIG. 12A shows the output of a simple program, described below, that applies a first-order HR filter to an input signal. The input signal is represented by the column of floating-point values 1202. These input values correspond to the magnitude of an input signal at successive time points indicated in a first column 1204, with values that start from an initial time point 1206 and end with a final time point 1208. A third column 1210 represents a response to the input signal generated by applying the first-order IIR filter to the input signal. The first-order IIR filter tends to introduce a time lag as well as to decrease the height of impulse spikes in the input signal. For example, an impulse occurs during time period 1212 that is reflected as a lower, and more spread out peak 1214 in the response. If the input signal is being analyzed to detect significant, broad peaks with magnitudes greater than 250.0, then review of the response up through time point 1216 shows no peak with that magnitude, even though the impulse in the input signal had a magnitude that exceeded 250.0 for two time points 1218. However, for the broad peak in the input signal starting at time point 1220 and extending to the end of the time points 1208, the magnitudes of the response eventually rise above the 250.0 threshold 1222. Thus, the first-order IIR filter produces a response that is useful in differentiating narrow impulse spikes in the input signal from broad peaks that need to be recognized by an automated monitor.

FIG. 12B shows a simple C++ program that implements the first-order IIR filter and it was used to generate the input-signal and response illustrated in FIG. 12A. The program includes a class declaration 1230 for a class in_out that implements the first-order IIR filter. The member function input 1232 receives, as a single argument, a floating-point value d representing the magnitude of the input signal at a next time point and computes the response at that time point. Implementation of the member function input is shown in the code section 1234. The response to the input-signal magnitude d is computed in line 1236 as the sum of a first term and a second term. The first term is computed on line 1238 as the product of a constant k and the input-signal magnitude d. The constant k is selected from the open range of floating-point values (0, 1), with smaller values corresponding to stronger impulse filtering. For the first time point, the second term is 0, as computed on lines 1240. Otherwise, as computed on line 1242, the second term is computed as 1−k times the response previously computed for the previous input-signal magnitude.

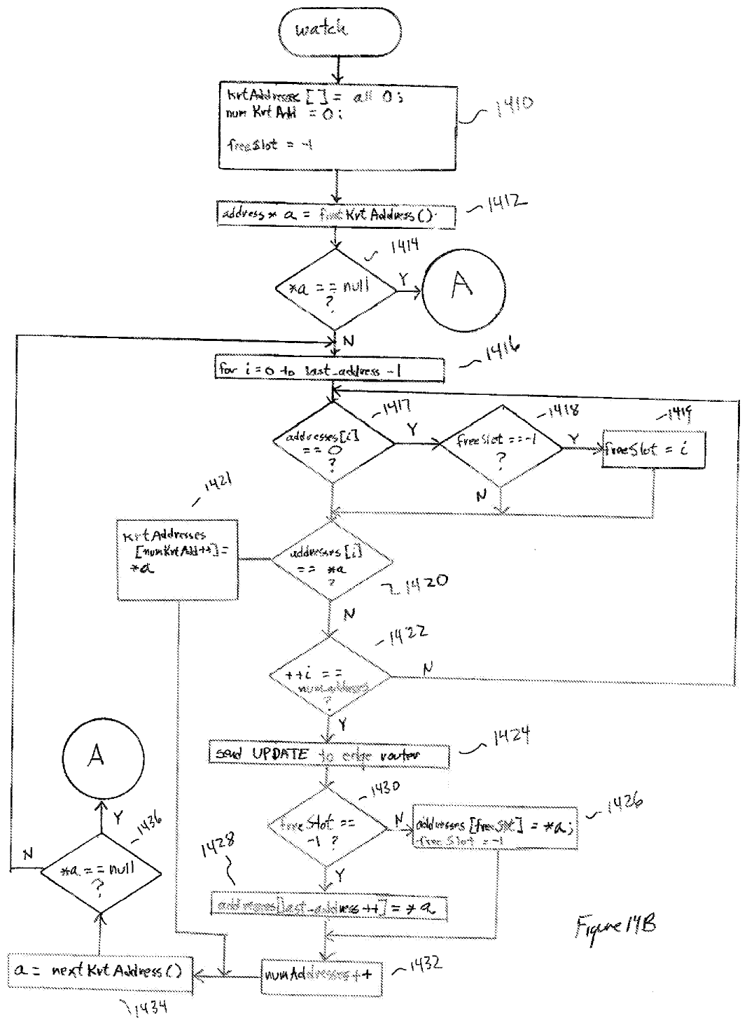

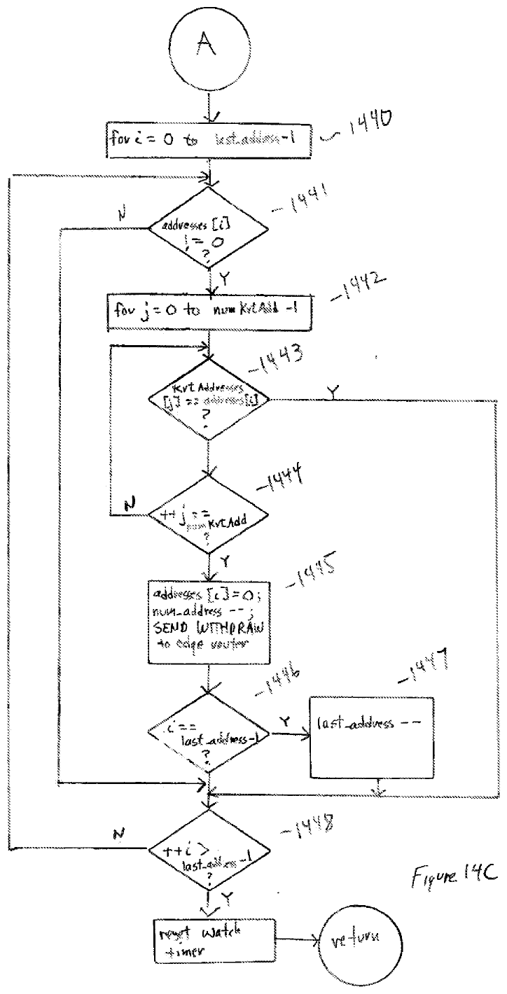

FIG. 13 illustrates the logger component of the currently disclosed subsystem. As discussed above, the logger 1302 receives rule-violation alerts from the internal server firewall 1304 via the netlink channel 1306. The logger uses the user-accessible krt 1308 for communication with the BGP routing daemon. In the currently described implementation, the logger maintains an internal logger table 1310 with entries describing source addresses identified in alert messages received from the server firewall associated with violation of metering rules configured in the server firewall. A metering, or rate-limiting, rule requires that the rate of incoming network messages from a particular source address needs to remain below a rule-specified maximum rate. When the metering rule is violated, the server firewall is configured to send an alert message identifying the source address responsible for the violation through the netlink channel 1306 to the logger. The logger includes an alert monitor 1312 which monitors the netlink channel for alert messages. When an alert for a metering-rule violation is received for a source address for which there is not an entry in the logger table, the alert monitor is responsible for adding an entry to the logger table for the source address. The entry includes a running metering-rule-violation rate generated by first-order IIR filtering of the metering-rule-violations, notifications of which are received as alerts by the logger. When the running metering-rule-violation rate exceeds a threshold value, and when the current available network bandwidth has decreased below a second threshold value, where the current available network bandwidth is provided by a bandwidth monitor 1314, the alert monitor enters the source address into an entry 1316 of the krt 1308 to request that the BGP routing daemon send an UPDATE message to the edge router. An additional monitor 1320 within the logger monitors the logger table to update logger-table entries, with the passage of time, and to clear addresses from the krt when the likelihood that null routing of a particular source address is no longer needed.

The format of an entry of the logger table 1330 is shown at the top of FIG. 13. The entry includes a source-address field address 1332, an field info 1334 that includes a subfield count 1336, a subfield rate 1338 that contains the running, IIR-filtered metering-rule-violation rate for the source address, and a subfield t_init 1340 that contains an indication of the initial time of metering-rule violations associated with the source address. A field t 1342 indicates the last time when the entry was updated by incrementing the count stored in the info.count subfield. A field status 1344 indicates whether or not the source address is currently null routed. A field num 1346 indicates the number of times the source address has been null routed since the time indicated by the info.t_init subfield. As with many of the other implementation details shown with respect to the currently discussed implementation of the currently disclosed subsystem, there are many different possible alternative ways for implementing the logger in many different alternative possible logger tables that can be used to store relevant information with respect to null-routing of source addresses.

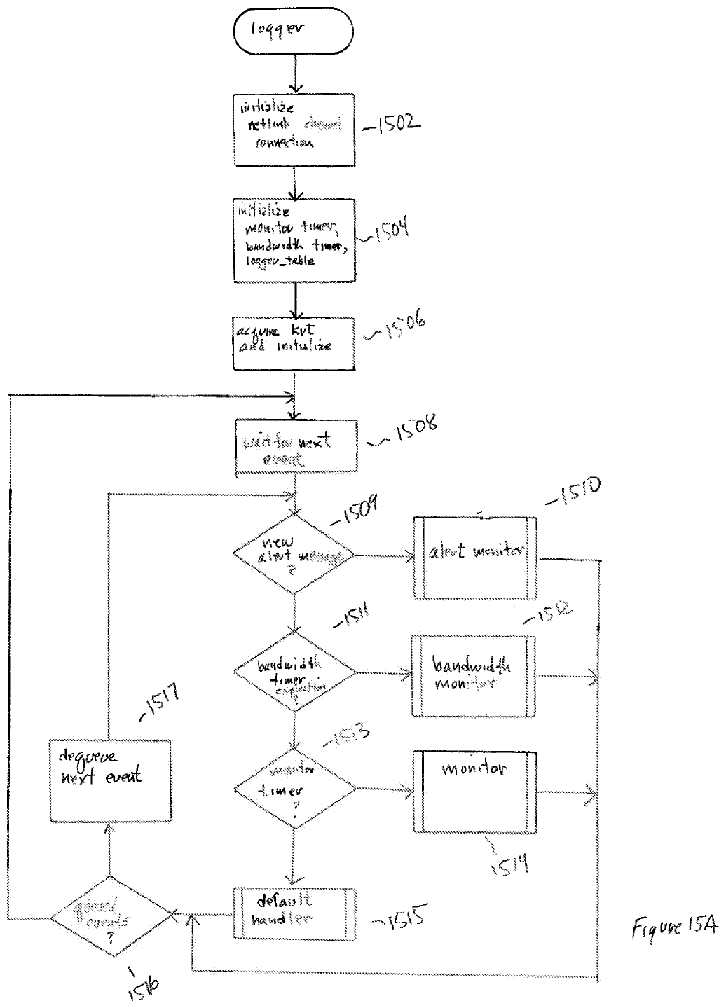

FIGS. 14A-C provide control-flow diagrams that illustrate operation of the BGP routing daemon. FIG. 14A provides a high-level control-flow diagram for the BGP routing daemon. In step 1402, the BGP routing daemon is initialized, which involves initialization of communications with the edge router and initializing internally maintain data structures and configurable parameters. In step 1403, the internal address list, represented by array addresses[ ], is initialized to have all empty entries, the local variables num_addresses and last_address are initialized to 0, and a watch timer is initialized to expire at the next monitoring interval for the BGP routing daemon. The local variable num_addresses indicates the number of addresses currently stored in the internal address list and the local variable last_address indicates the last entry in the internal address list. This value may be different from num_addresses−1 due to the presence of empty entries. The BGP routing daemon comprises a continuous event-handling loop of steps 1404-1408, with the BGP routing daemon waiting, in step 1404, for the occurrence of a next event and then handling the event by calling an appropriate event handler. Ellipsis 1410 indicates that there may be additional types of events that are handled that are not shown in FIG. 14A. Once the most recently occurring event has been handled, control flows back to step 1404 in the case that there are no additional events queued for handling, as determined in step 1407, or flows back to step 1405 when there are additional queued events. When the next-occurring event is a watch-timer expiration, as determined in step 1405, a handler watch is called in step 1406.

FIGS. 14B-C show a control-flow diagram for the watch handler called in step 1404 of FIG. 14A. In an initialization step 1410, the watch handler initializes a local array krtAddresses to contain all 0 entries, a local variable numKrtAdd to 0, and a local variable freeSlot to −1. The local array krtAddresses keeps track of the source addresses currently included in the krt and the variable freeSlot contains an index for the first free entry in the internal address list. In step 1412, an address pointer a is initialized to point to the first source address stored in the krt table. When this pointer has a null value, as determined in step 1414, control flows to the first step in FIG. 14C, since an initial loop through the source addresses stored in the krt table has completed. In the for-loop of steps 1416-1422, the internal address list of the BGP routing daemon is searched for an entry containing the source address pointed to by pointer a. If, during the search, an empty entry in the internal address list is identified, in step 1417, and if the local variable freeSlot does not already point to an empty entry, as determined in step 1418, the local variable freeSlot is set to the index of the free slot in step 1419. When an entry in the internal address list with a source address matching the address pointed to by pointer a is found, as determined in step 1420, the address is added to the local array krtAddresses, in step 1421, and the for-loop terminates. When the for-loop of steps 1416-1422 completes without finding a matching entry, the source address pointed to by pointer a is a new source address added to the krt. As a result, an UPDATE message is sent to the edge router, in step 1424, and the source address is added to the internal address list in either step 1426 or step 1428, depending on whether a free address is pointed to by the local variable freeSlot, as determined in step 1430. In step 1432, the current number of addresses in the internal address list is incremented. In step 1434, the pointer a is updated to point to a next source address in the krt. If the pointer a is null, as determined in step 1436, control flows to the first step in FIG. 14C, since all of the addresses currently stored in the krt have been considered. Otherwise, control flows back to step 1416 to attempt to match the address pointed to by pointer a to an address in the internal address list of the BGP routing daemon. In the for-loop of steps 1440-1448 shown in FIG. 14C, each address stored in the internal address list of the BGP routing daemon is considered. In the inner for-loop of steps 1442-1444, the currently considered address stored in the internal address list is attempted to be matched to an address stored in the local array krtAddresses. If no such address can be found, then the currently considered source address has been removed from the krt. As result, in step 1445, the BGP routing daemon removes the address from the internal address list and sends a WITHDRAW message to the edge router.

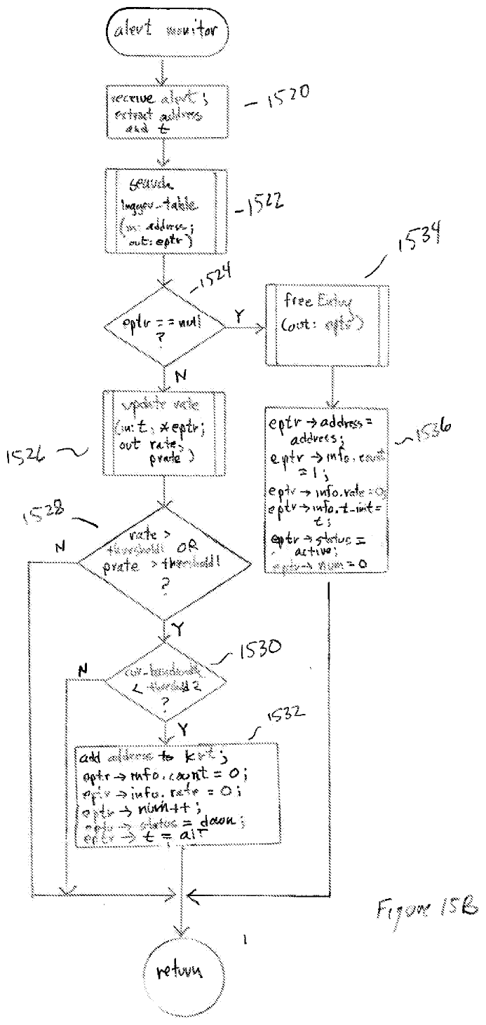

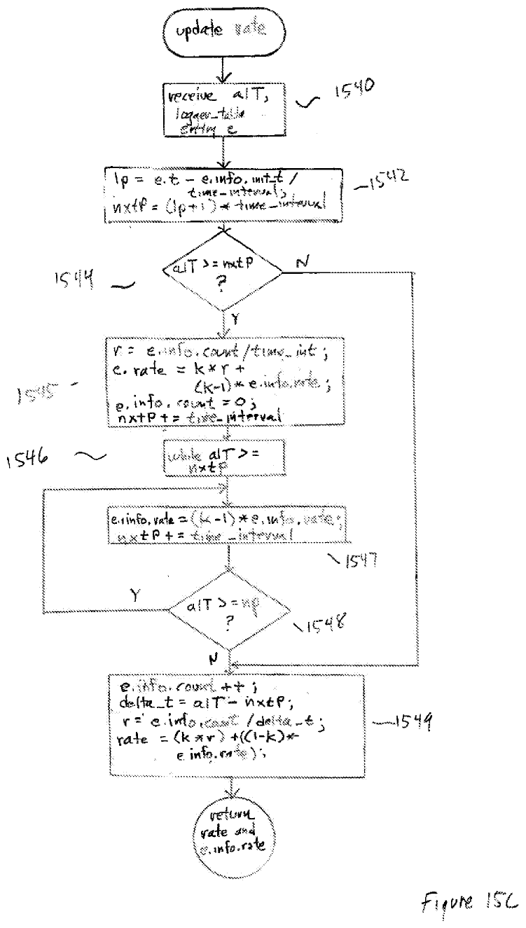

FIGS. 15A-C provide control-flow diagrams for the logger component of the currently discussed implementation of the currently disclosed subsystem. FIG. 15A provides a high-level flow diagram for the logger. In step 1502, the logger initializes the netlink channel for receiving alerts from the firewall. In step 1504, the logger initializes a monitor timer, a bandwidth timer, and the logger table. In step 1506, the logger initializes use of the krt and initializes the krt. Steps 1508-1517 together comprise a continuous event loop in which the logger handles the various logger events. Newly arriving alert messages from the firewall are handled by calling the alert monitor handler, in step 1510. Expiration of the bandwidth timer is handled by calling the bandwidth monitor handler, in step 1512. This handler is not further described since the bandwidth monitor needs to simply update the current available bandwidth for the network connection. The bandwidth monitor may obtain this information from various sources in different implementations. Expiration of the monitor timer is handled by calling the monitor handler in step 1514.

A control-flow diagram for the alert monitor handler, called in step 1510 of FIG. 15A, is provided in FIG. 15B. In step 1520, the alert monitor receives an alert from the firewall and extracts a source address address from the alert as well as determining a time t for the alert. In step 1522, the alert monitor searches the logger table for the source address. When the search returns a non-null logger-table entry pointer eptr, as determined in step 1524, the alert monitor calls a routine “update rate,” in step 1526, to apply the first-order IIR filter to the detected rate of metering-rule violations for the source address. The routine “update rate” returns a current filtered violation rate rate and the previous filtered violation rate prate for the source address. When either of the returned rates exceeds a first threshold, as determined in step 1528, and when the currently available networking bandwidth is less than a second threshold, as determined in step 1530, the source address is added to the krt and the logger-table entry for the source address is updated and step 153. When there was no entry for the source address in the logger table, as determined in step 1524, eptr is set to a free-entry in the logger table, in step 1534, and, in step 1536, the entry of the logger table pointed to by eptr is initialized.

A control-flow diagram for the routine “update rate,” called in step 1526 of FIG. 15B, is provided in FIG. 15C. In step 1540, the routine “update rate” receives the time of the alert alT and a logger-table entry e. In step 1542, the routine “update rate” sets local variable nextP to the time of the next counting interval following the counting interval during which the last update of the logger-table entry was made. When the alert time alT is greater than nextP, as determined in step 1544, the IIR-filtered rule-violation rate is updated in steps 1545-1548 up to the current counting interval. In step 1549, the routine “update rate” computes the current IIR-filtered rule-violation rate and this current rate and the previous rate are then returned.

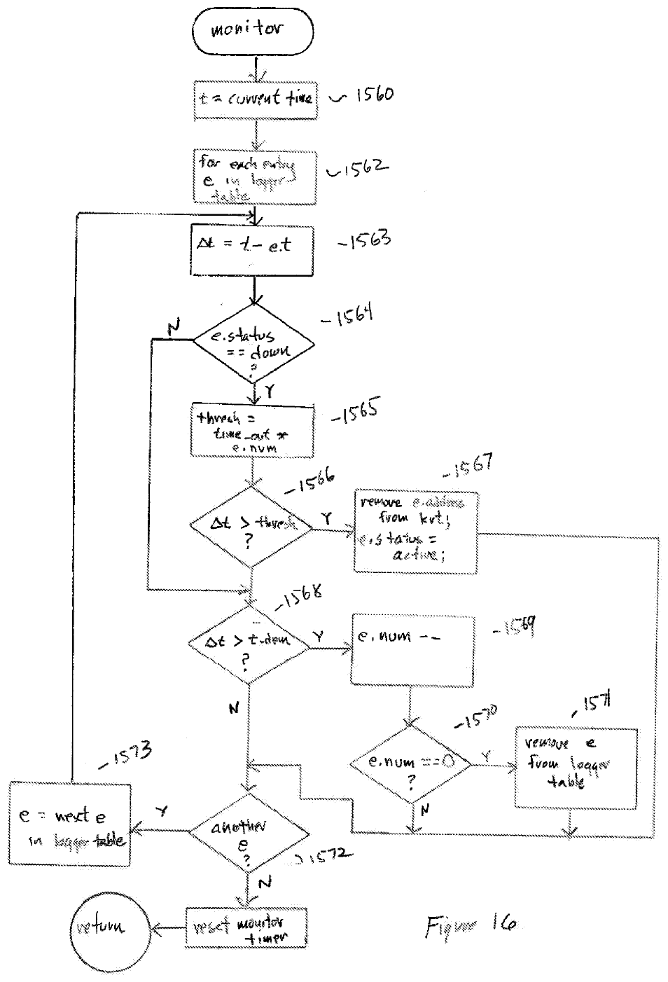

FIG. 16 provides a control-flow diagram for the monitor handler called in step 1514 of FIG. 15A. In step 1560, local variable t is set to the current time. Then, in the for-loop of steps 1562, each entry e in the logger table is considered. In step 1563, a difference Δt between the current time in the last time that the currently considered entry e was updated is computed. When the currently considered entry corresponds to a source address that is currently null routed, as determined in step 1564, a threshold time is computed in step 1565 as a basic time-out period multiplied by the number of times that the source address has been null routed. When the computed difference Δt is greater than this threshold time interval, as determined in step 1566, the source address is removed from the krt and the logger-table entry e is updated to indicate that the source address is no longer null routed, in step 1567. When the logger-table entry e corresponds to a source of address that is not currently null routed, as determined in step 1564, and when the computed difference Δt is greater than a time period t_dem for relaxing the count of the number of times the source address has been null routed, as determined in step 1568, the field e.num is decremented, in step 1569, When the field e.num has the value 0, as determined in step 1570, the entry e is removed from the logger table, in step 1571, since of the source address is no longer viewed as a threat.

The present invention has been described in terms of particular embodiments, it is not intended that the invention be limited to these embodiments. Modifications within the spirit of the invention will be apparent to those skilled in the art. As discussed above, many of the different components of the currently disclosed subsystem implementation may be alternatively implemented by using different underlying features and functionalities with the server. While the above discussion focused on a single network connection and single edge router, the above discussed subsystem is straightforwardly implemented to monitor multiple network connections for DoS attacks and to deflect the attacks at multiple network boundaries and/or interfaces. In different implementations, the currently disclosed methods can be incorporated in various different layers of a computer system, including the application layer, operating-system layer, virtualization layers, and even in hardware components.

1. A subsystem of a computer system that detects and deflects denial-of-service attacks, the subsystem comprising:
a computer system that includes one or more processors, one or more memories, and one or more mass-storage devices; and
computer instructions, stored in one or more of the one or more memories that, when executed by one or more of the one or more processors, control the computer system to
monitor, by a logging component of the subsystem, incoming network traffic to detect network-message floods and determine one or more source addresses of remote entities that are sources of the network-message floods, and
deflect, by a deflection component of the subsystem, network messages directed to the computer system at a network boundary when the deflection component is notified by the logging component of a source address associated with a network-message flood.

2. The subsystem of claim 2 wherein the deflection component includes a daemon that communicates with an edge router at the network boundary.

3. The subsystem of claim 3 wherein, when the deflection component is notified, by the logging component, of a source address associated with a network-message flood, the deflection component sends an UPDATE request to the edge router to request the edge router to null route the source address.

4. The subsystem of claim 4 wherein, when the deflection component is notified, by the logging component, of a source address that was previously associated with a network-message flood but for which null routing can now be terminated, the deflection component sends a WITHDRAW request to the edge router to request the edge router to terminate null routing of the source address.

5. The subsystem of claim 2 wherein the logging component communicates a source address associated with a network-message flood to the deflection component using operating-system-provided stored data shared by the logging component and the deflection component.

6. The subsystem of claim 5 wherein the operating-system-provided stored data is a user-accessible kernel routing table.

7. The subsystem of claim 1 wherein the logging component includes:
an alarm monitor;
a bandwidth monitor;
a monitor; and a logger table.

8. The subsystem of claim 7 wherein the alarm monitor
receives metering-rule-violation alerts for a firewall within the computer system that each indicates that a particular source address is included in a series of network messages received at a rate that exceeds a threshold rate specified by the metering rule.

9. The subsystem of claim 8 wherein, when the alarm monitor receives an alert, the alarm monitor checks the logger table for an entry corresponding to the source address in the alert.

10. The subsystem of claim 9 wherein, when no entry is found for the source address in the logger table, the alarm monitor places a new entry for the source address in the logger table.

11. The subsystem of claim 9 wherein, when an entry is found for the source address in the logger table, the alarm monitor
determines calculates an impulse-filtered metering-rule-violation rate for the source address from information contained in the entry;
when the calculated impulse-filtered metering-rule-violation rate exceeds a first threshold value, and when the available network bandwidth has fallen below a second threshold value,
notifies the deflection component that the source address is to be null routed, and
updates the entry to indicate that the source address is null routed.

12. The subsystem of claim 9 wherein the bandwidth monitor periodically determines the current available remaining network bandwidth.

13. The subsystem of claim 9 wherein the monitor periodically reviews each entry in the logger table.

14. The subsystem of claim 13 wherein, when a logger-table entry reviewed by the monitor corresponds to an active, non-null-routed source address for which a third threshold time has passed without incurring any metering-rule violations, the monitoring component removes the entry from the logger table.

15. The subsystem of claim 14 wherein the third threshold time has a length corresponding to a number of previous null-routings of the source address.

16. The subsystem of claim 13 wherein, when a logger-table entry reviewed by the monitor corresponds to an inactive, null-routed source address for which fourth threshold time has passed, the monitor
notifies the deflection component to terminate null routing of the source address; and
updates the logger-table entry to indicate that the source address is active and non-null-routed.

17. The subsystem of claim 16 wherein the fourth threshold time has a length corresponding to a number of previous null-routings of the source address.

18. A method that detects and deflects denial-of-service attacks carried out by a subsystem of a computer system that includes one or more processors, one or more memories, and one or more mass-storage devices, the method comprising:
monitoring incoming network traffic to detect network-message floods and determine one or more source addresses of remote entities that are sources of the network-message floods, and
deflecting network messages directed to the computer system at a network boundary when the deflection component is notified by the logging component of a source address associated with a network-message flood.

19. The method of claim 18 wherein the deflection occurs within an edge router at the network boundary.

20. A data-storage device encoded with computer instructions that, when executed by one or more processors of a computer system, control the computer system to:
monitor incoming network traffic to detect network-message floods and determine one or more source addresses of remote entities that are sources of the network-message floods, and
deflect network messages directed to the computer system at a network boundary when the deflection component is notified by the logging component of a source address associated with a network-message flood.
